(19) United States
(12) Patent Application Publication
(10) Pub. No.: US 2026/0140084 A1
(43) Pub. Date: May 21, 2026

(54) METHOD FOR OPERATING A SENSOR FOR DETECTING AT LEAST ONE PROPERTY OF A MEASUREMENT GAS IN A MEASUREMENT GAS CHAMBER

(71) Applicant: Robert Bosch GmbH, Stuttgart (DE)

(72) Inventors: Andreas Schwaerzle, Stuttgart (DE); Christian Schmid, Ditzingen-Hirschlanden (DE)

(21) Appl. No.: 19/117,529

(22) PCT Filed: Sep. 21, 2023
(86) PCT No.: PCT/EP2023/075993

§ 371 Date: Apr. 1, 2025

(30) Foreign Application Priority Data
Oct. 19, 2022 (DE) 10 2022 211 060.9

(51) Int. Cl. G01N 27/406; G01M 15/10; G01N 27/41

(52) U.S. Cl. CPC G01N 27/4067; G01M 15/104; G01N 27/41

(57) ABSTRACT

A method for operating a sensor for detecting at least one property of a measurement gas in a measurement gas chamber. The method includes: heating the sensor element using a heating element, detecting an electrical resistance of a Nernst cell and generating a signal indicating the resistance of the Nernst cell, detecting an electrical resistance of a pump cell and generating a signal indicating the resistance of the pump cell, evaluating a temporal profile of the signals indicating the resistance of the pump cell and Nernst cell. A check is made here to ascertain whether the signal indicating the resistance of the pump cell and/or Nernst cell falls below a resistance threshold value.

### BACKGROUND INFORMATION

A plurality of sensors and methods for detecting at least one property of a measurement gas in a measurement gas chamber are described in the related art. In principle, this can involve any physical and/or chemical properties of the measurement gas, wherein one or more properties can be detected. The present invention is described below in particular with reference to a qualitative and/or quantitative detection of a content of a gas component of the measurement gas, in particular with reference to a detection of an oxygen content in the measurement gas portion. The oxygen content can be detected, for example, in the form of a partial pressure and/or in the form of a percentage. Alternatively or additionally, however, other properties of the measurement gas can also be detected, such as the temperature.

In particular, ceramic sensors are described in the related art, which are based on the use of electrolytic properties of certain solids, i.e., on ion-conducting properties of these solids. In particular, these solids can be ceramic solid electrolytes, such as zirconium dioxide (ZrO₂), in particular yttrium-stabilized zirconium dioxide (YSZ) and scandium-doped zirconium dioxide (ScSZ), which can contain small added amounts of aluminum oxide (Al₂O₃) and/or silicon oxide (SiO₂).

For example, such sensors can be designed as so-called lambda probes or as nitrogen oxide sensors, as are described, for example, in K. Reif, Deitsche, K-H. et al., “Kraftfahrtechnisches Taschenbuch” [Automotive Handbook], Springer Vieweg, Wiesbaden, 2014, pages 1338-1347. With wideband lambda probes, in particular with planar wideband lambda probes, for example, the oxygen concentration in the exhaust gas can be determined over a wide range and the air-fuel ratio in the combustion chamber can thus be deduced. The air ratio ) (lambda) describes this air-fuel ratio. Nitrogen oxide sensors determine both the nitrogen oxide concentration and the oxygen concentration in the exhaust gas.

By combining a pump cell, the measuring cell, and an oxygen reference cell, the Nernst cell, a sensor can be constructed to measure the oxygen content in an ambient gas. In a pump cell that operates according to the amperometric pumping principle, when a voltage or current is applied to the pump electrodes, which are located on different gases, a current of oxygen ions diffuses through a ceramic body (the oxygen-ion-conducting solid electrolyte), which separates the gases from one another (“pumping”). If the pump cell is used to keep the oxygen partial pressure constant in a cavity into which the ambient gas can diffuse, then the amount of oxygen transported can be deduced by measuring the electrical current. According to the law of diffusion, this pump current is directly proportional to the oxygen partial pressure in the ambient gas. Using a Nernst cell, the ratio of the oxygen partial pressure in the cavity to the oxygen partial pressure in a further reference gas chamber can be determined via the resulting Nernst voltage.

In order to comply with applicable emissions regulations, the use of various other conventional exhaust gas sensors for exhaust gas aftertreatment in modern internal combustion engines is indispensable. NOx sensors, particulate sensors, wideband lambda probes, and binary jump probes are used, the jump probes only being used in gasoline or gas engines. The lambda signal is used, for example, to meter the fuel quantity, improve exhaust gas aftertreatment, and monitor the three-way catalyst efficiency. The NOx sensors can be used to ascertain the nitrogen oxide concentration and the oxygen concentration in the exhaust gas. When they are used downstream of SCR catalysts, the ammonia concentration can also be determined. In NOx storage catalysts, the loading, or the end of the possibility of storage, is thereby detected, while the urea-water solution is metered precisely in SCR catalysts.

The exhaust gas sensors mentioned are provided with heating elements in order to ensure that they function quickly and with high accuracy. The heating element of the particulate sensor is used to regenerate the sensor element, the soot being burnt off by heating during the regeneration. The heating element is only operated transiently here. The other sensors only function with high accuracy at a sufficiently high working temperature of the probe ceramic and are therefore continuously heated to a specified target temperature. The newer-generation sensors are equipped with increasingly powerful heating elements to minimize exhaust emissions during starting of internal combustion engines.

The particulate sensor has an integrated temperature measuring element with a measuring range of −40° C. to 950° C. in order to allow precise control of the regeneration. In the case of NOX probes and lambda probes, however, the temperature of the sensor element is ascertained via the internal electrical resistance of the probe ceramic. This internal resistance can only be measured above an elevated temperature, depending on the particular sensor element and the evaluation logic used (analog circuit or ASIC).

Typical wideband probes are so-called two-cell probes, in which the function is ensured by a pump cell (line APES to the outer pump electrode, line IPE to the inner pump electrode) and a Nernst cell (line IPE to the inner pump electrode, line RE to the reference electrode). By measuring the resistance of the corresponding cell, the temperature of the sensor element can be deduced. Typically, the resistances of the pump cell and Nernst cell have negative temperature coefficients so that the electrical resistance of the cells decreases at higher temperatures. In contrast to the pump cell, the Nernst cell is not directly exposed to the exhaust gas and therefore exhibits fewer aging phenomena over its lifetime, which manifest themselves in deviations from the specified relationship between resistance and temperature. The resistance of the Nernst cell is therefore used for more precise temperature control.

The heating-up phase of the probes is determined on the basis of a heat-up profile in the form of a voltage profile defined in the technical customer documentation. Since the voltage supply, which usually corresponds to the vehicle electrical system voltage, cannot typically be controlled itself, the desired effective voltage is ensured by a heater output stage using pulse width modulation.

In order to ensure overheating protection of the probe, a maximum heating-up time is defined. If no valid temperature signal is available via the resistance of the Nernst cell (e.g., due to a line interruption (OL) ), the probe heating must be switched off or reduced after this time has elapsed, in order to avoid overheating and thus damage to the probe. The specified maximum time takes into account manufacturing variation, aging effects of the heater resistor, and critical ambient conditions for the specified heating voltage profile and is typically designed for a vehicle electrical system voltage above 12 V.

Line interruptions at the outer pump electrode, inner pump electrode, and reference electrode are diagnosed by continuously evaluating the measured resistances of the Nernst cell and pump cell after the maximum heating-up time has elapsed. The enable time point of the diagnosis of line interruptions thus typically ensures the overheating protection of the sensor since the probe heating is switched off or reduced after an OL fault detection.

The heating performance diagnosis is also based on a temperature derived from the resistance of the Nernst cell. It is therefore not possible to clearly distinguish whether the resistance of the probe ceramic is still outside the measurable range due to the temperature being too low (possible heating performance fault) or whether there is an open signal line (OL fault) at the Nernst cell. When a vehicle is homologated, it must be demonstrated to the authorities that a heater that is marginally within the specification (WPA, or worst performance acceptable, heater) can be robustly distinguished, using the heating performance diagnosis, from a heater that is too weak (BPU, or best performance unacceptable, heater). It is critical here that, when the diagnosis of signal line interruptions is enabled, an OL fault is not incorrectly indicated due to a probe that is too cold but is still very dynamic in the heating-up process.

Despite the advantages provided by these sensors and methods for monitoring their functionality, there is still room for improvement. For example, when a vehicle is homologated, a WPA heater must be distinguished from a BPU heater on the basis of different additional resistances in the heater circuit. Hardware variations between vehicles (wiring harness, probes, etc.) can mean that no specific additional resistance can be specified for the heater circuit in order to reliably demonstrate the heating performance fault (BPU heater). Only a very narrow corridor (approx. 50 mohms) remains for reliable heating performance fault detection, which is very easily exceeded by hardware variations. This can result in additional measurement effort of approximately 3 days per demonstration vehicle in order to redetermine a vehicle-specific BPU heater additional resistance.

### SUMMARY

According to an example embodiment of the present invention, a method for operating a sensor for detecting at least one property of a measurement gas in a measurement gas chamber is provided, which method at least largely avoids the disadvantages of conventional methods for operating these sensors and which is in particular suitable for improving the fault pinpointing between an open signal line and a heating performance fault (cold probe or probe heating up too slowly), and for ensuring safe heating backup operation in the event of a line interruption at the pump cell or Nernst cell (APES or RE line).

A method according to an example embodiment of the present invention for operating a sensor for detecting at least one property of a measurement gas in a measurement gas chamber, in particular for detecting a content of a gas component in the measurement gas, wherein the sensor has a sensor element for detecting the property of the measurement gas, wherein the sensor element has at least one Nernst cell, at least one pump cell, and at least one heating element, comprises the following steps, preferably in the specified order:
a) heating the sensor element by means of the heating element for a predetermined heating period,
b) detecting an electrical resistance of the Nernst cell during the predetermined heating period and generating a signal indicating the resistance of the Nernst cell,
c) detecting an electrical resistance of the pump cell during the predetermined heating period and generating a signal indicating the resistance of the pump cell,
d) evaluating a temporal profile of the signals indicating the resistance of the pump cell and Nernst cell, wherein a check is made as to whether the signal indicating the resistance of the pump cell and/or Nernst cell falls below a resistance threshold value within the predetermined heating period, wherein
e) if the evaluation reveals that the signal indicating the resistance of the Nernst cell does not fall below the resistance threshold value within the predetermined heating period, but the signal indicating the resistance of the pump cell has already fallen below the resistance threshold value, a temperature of the sensor element is controlled on the basis of the signal indicating the resistance of the pump cell,
f) if the signal indicating the resistance of the Nernst cell still falls below the resistance threshold value before the diagnosis of line interruptions is enabled, regular heating operation is carried out by means of temperature control on the basis of the resistance of the Nernst cell.

On the basis of the pump cell resistance, which is additionally used as sensor temperature information, it is possible to detect much earlier than before whether the sensor is heating up. At the same time, overheating of the sensor can be excluded if the heating-up phase is extended beyond the predetermined heating period, since temperature control is carried out on the basis of the internal resistance of the pump cell in the absence of a temperature signal or internal resistance of the Nernst cell. The predetermined heating period is the maximum allowed heating-up period without sensor temperature information before the sensor must be transferred to safe heating element operation in order to avoid overheating.

If there is an OL fault on the IPE line, no change in resistance from the maximum detectable resistance value can be measured at either the Nernst cell or the pump cell within the predetermined heating period. In order to prevent this fault, the resistance for the pump cell or Nernst cell must fall below a certain resistance threshold value within the predetermined heating period. For this purpose, the temporal profile of the resistance of the pump cell and Nernst cell is observed or detected.

During the heating-up process of the sensor, a measurable change in resistance of the Nernst cell occurs at a later point in time than in the pump cell, which is why valid temperature information of the sensor is available earlier via the pump cell at the same resistance threshold value, and overheating of the Sensor can thus be ruled out.

The resistance threshold value defines a resistance value below which valid temperature information for the pump cell and/or Nernst cell can be assumed.

According to an example embodiment of the present invention, the method can further comprise arranging additional resistances of different magnitudes in a circuit of the heating element, wherein steps a) to f) are each carried out with the additional resistances of different magnitudes.

The method of the present invention described above thus allows an optimization of the heating strategy for sensors with reduced heating performance, e.g., owing to additional resistances in the heater circuit, taking into account the measured pump cell resistance, and improves the overheating protection in case of OL faults by means of temperature control on the basis of the internal resistance of the pump cell. As a result, the enabling of the diagnosis of line interruptions no longer has to be designed to ensure overheating protection in the event of an OL fault, but can be carried out with a time delay of a few seconds after the predetermined heating period has elapsed, in order to represent an additional improvement of the fault pinpointing between an open signal line and a heating performance fault. The reason for this is that, in the case of a reduced heating performance, the resistance values for the Nernst cell and pump cell already show significantly lower values after a slight delay in enabling the diagnosis.

When a vehicle is homologated, a WPA heater must be distinguished from a BPU heater on the basis of different additional resistances in the heater circuit. Since the pump cell of a two-cell probe typically has a lower internal resistance than the Nernst cell at the same temperature, the heating-up of the sensor element can be detected early on the basis of its signal profile. This can be used to extend the heating-up phase, since an OL-IPE fault and thus overheating of the sensor can be ruled out in this case. As a result, a higher additional resistance can be selected for the BPU heater in order to increase the robustness of correct fault detection during the official demonstration and to minimize additional measurement effort. The time delay described above for falling below the resistance threshold value of the Nernst cell and pump cell, overheating of the sensor can thereby be excluded and the heating strategy can be optimized, as well as the decoupling of the overheating protection from the enabling of the diagnosis of line interruptions, allows the targeted selection of a (higher) additional resistance in order to be able to distinguish a WPA heater from a BPU heater robustly, taking into account all possible operating and vehicle variations.

The resistance threshold value below which valid temperature information for the pump cell and/or Nernst cell can be assumed can be 4000 ohms to 8000 ohms and preferably 7000 ohms to 8000 ohms.

For an enlarged resistance measuring range, significantly higher values of 50 kohms to 150 kohms are preferably used for the resistance threshold value. Heating-up of the sensor element can thus be reliably detected.

According to an example embodiment of the present invention, the method can further comprise identifying an interruption in a line to the Nernst cell and/or pump cell after the diagnosis of line interruptions has been enabled, and ensuring the overheating protection of the sensor element if the signal indicating the resistance of the Nernst cell and/or pump cell does not fall below the resistance threshold value within the predetermined heating period.

According to an example embodiment of the present invention, if an interruption in the line to the Nernst cell is identified, a temperature of the sensor element can be controlled on the basis of the signal indicating the resistance of the pump cell. Instead of a constant heater voltage as before, if there is no temperature signal or internal resistance of the Nernst cell, temperature control can be carried out on the basis of the internal resistance of the pump cell. Since no lambda signal is provided in this system state, a possibly more pronounced aging behavior of the pump cell has no negative effect on the injection control, but a possible overheating of the probe can be ruled out.

According to an example embodiment of the present invention, the method can further comprise identifying an intact line to the Nernst cell and/or pump cell after the diagnosis of line interruptions has been enabled, if the signal indicating the resistance of the Nernst cell and/or pump cell falls below the resistance threshold value within the predetermined heating period. This means that valid temperature information of the sensor is quickly available, possible overheating of the probe is excluded, and the heating strategy can be optimized at an early stage for sensors with reduced heating performance.

In a further aspect of the present invention, a system is provided. According to an example embodiment of the present invention, the system comprises at least one sensor for detecting at least one property of a measurement gas in a measurement gas chamber, in particular for detecting a content of a gas component in the measurement gas, wherein the sensor has a sensor element for detecting the property of the measurement gas, wherein the sensor element has at least one Nernst cell, at least one pump cell, and at least one heating element, and at least one controller. The controller includes at least one processor. The controller is designed to carry out the method steps according to the method of the present invention as described above or as described below.

In a further aspect of the present invention, a computer program is provided, which is configured to carry out the method of the present invention as described above or as described below when executed on a computer or computer network.

In a further aspect of the present invention, a computer program having program code means is provided. The computer program is designed to carry out the method of the present invention as described above or as described below when the program is executed on a computer or computer network.

In a further aspect of the present invention, a data carrier is proposed, on which a data structure is stored. The data structure is designed to execute the method of the present invention as described above or as described below after being loaded into a working and/or main memory of a computer or computer network.

In a further aspect of the present invention, a computer program product is provided having program code means stored on a machine-readable carrier, in order to carry out the method of the present invention as described above or as described below when the program is executed on a computer or computer network.

A computer program product is understood to be the program as a commercially available product. In principle, it can be in any form, for example on paper or on a computer-readable data carrier, and can in particular be distributed via a data transmission network. In particular, the program code means can be stored on a computer-readable data carrier and/or a computer-readable storage medium. The terms “computer-readable data carrier” and “computer-readable storage medium” as used herein may refer in particular to non-transitory data storage devices, such as a hardware data storage medium on which computer-executable instructions are stored. The computer-readable data carrier or the computer-readable storage medium can in particular be or comprise a storage medium such as a random-access memory (RAM) and/or a read-only memory (ROM).

In a further aspect of the present invention, a modulated data signal is provided, wherein the modulated data signal comprises instructions executable by a computer system or computer network for carrying out a method of the present invention as described above or as described below.

Finally, the present invention also relates to a sensor for detecting at least one property of a measurement gas in a measurement gas chamber, in particular for detecting a content of a gas component in the measurement gas or a temperature of the measurement gas. According to an example embodiment of the present invention, the sensor comprises a sensor element for detecting the property of the measurement gas, wherein the sensor element has at least one Nernst cell, at least one pump cell, and at least one heating element, wherein the sensor further has an electronic control unit with the computer program according to the present invention for carrying out the method according to the present invention.

For example, the sensor element has a solid electrolyte, a first electrode, a second electrode, a third electrode, and a fourth electrode, wherein the first electrode and the second electrode are connected to the solid electrolyte such that the first electrode, the second electrode, and the solid electrolyte form a pump cell, wherein the third electrode and the fourth electrode are connected to the solid electrolyte such that the third electrode, the fourth electrode, and the solid electrolyte form a Nernst cell.

In the context of the present invention, a solid electrolyte is understood to mean a body or object with electrolytic properties, i.e., with ion-conducting properties. In particular, it can be a ceramic solid electrolyte. This also includes the raw material of a solid electrolyte and therefore the formation as a so-called green or brown body, which only becomes a solid electrolyte after sintering. In particular, the solid electrolyte can be formed as a solid electrolyte layer or from multiple solid electrolyte layers. In the context of the present invention, a layer is understood to mean a uniform mass in planar extension of a certain height, which lies above, below, or between other elements.

In the context of the present invention, an electrode is generally understood to mean an element that is capable of contacting the solid electrolyte such that a current through the solid electrolyte and the electrode can be maintained. Accordingly, the electrode can comprise an element at which the ions can be incorporated into and/or removed from the solid electrolyte. Typically, the electrodes comprise a precious metal electrode, which can be applied, for example, as a metal-ceramic electrode to the solid electrolyte or can be connected to the solid electrolyte in another way. Typical electrode materials are platinum cermet electrodes. However, other precious metals, such as gold or palladium, can also be used in principle.

In the context of the present invention, a heating element is understood to mean an element that is used to heat the solid electrolyte and the electrodes to at least their functional temperature and preferably to their operating temperature. The functional temperature is the temperature above which the solid electrolyte becomes conductive to ions and which is approximately 350° C. This must be distinguished from the operating temperature, which is the temperature at which the sensor element is usually operated and which is higher than the functional temperature. The operating temperature may, for example, be from 700° C. to 950° C. The heating element can comprise a heating region and at least one supply path. In the context of the present invention, a heating region is understood to mean the region of the heating element that, in the layer structure, overlaps with an electrode in a direction perpendicular to the surface of the sensor element. Usually, the heating region heats up more during operation than the supply path so that they can be distinguished. The different heating can be achieved, for example, by the heating region having a higher electrical resistance than the supply path. The heating region and/or the supply path are designed, for example, as an electrical resistance path and heat up when an electrical voltage is applied. The heating element may, for example, be produced from a platinum cermet.

### BRIEF DESCRIPTION OF THE DRAWINGS

Further optional details and features of the present invention result from the following description of preferred exemplary embodiments shown schematically in the figures.

FIG. 1 shows a basic structure of a sensor according to an example embodiment of the present invention.

FIG. 2 is a flowchart of a method according to an example embodiment of the present invention for operating the sensor.

FIG. 3 shows exemplary signal profiles of the sensor of the present invention during operation of the heating element.

### DETAILED DESCRIPTION OF EXAMPLE EMBODIMENTS

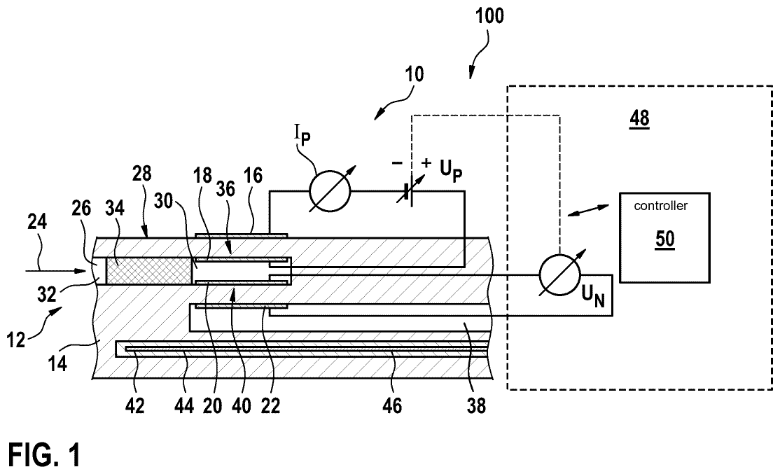

FIG. 1 shows a basic structure of a sensor 10 according to the present invention. The sensor 10 shown in FIG. 1 can be used to detect physical and/or chemical properties of a measurement gas, wherein one or more properties can be detected. The present invention is described below in particular with reference to a qualitative and/or quantitative detection of a gas component of the measurement gas, in particular with reference to a detection of an oxygen content in the measurement gas. The oxygen content can be detected, for example, in the form of a partial pressure and/or in the form of a percentage. In principle, however, other types of gas components can also be detected, such as nitrogen oxides, hydrocarbons, and/or hydrogen. Alternatively or additionally, however, other properties of the measurement gas can also be detected. The present invention can be used in particular in the field of automotive engineering so that the measurement gas chamber can in particular be an exhaust tract of an internal combustion engine, and the measurement gas can in particular be an exhaust gas. For example, the sensor 10 is designed as a lambda probe, in particular as a wideband lambda probe, as explained in more detail below. However, it is explicitly emphasized that the sensor 10 may alternatively be a jump probe.

The sensor 10 has a sensor element 12. The sensor element 12 can be designed as a ceramic layer structure, as described in more detail below. The sensor element 12 has a solid electrolyte 14, a first electrode 16, a second electrode 18, a third electrode 20, and a fourth electrode 22. The solid electrolyte 14 can be composed of multiple ceramic layers in the form of solid electrolyte layers or can comprise multiple solid electrolyte layers. For example, the solid electrolyte 14 comprises a pumping foil or pumping layer, an intermediate foil or intermediate layer, and a heating foil or heating layer, which are arranged one above the other or one below the other. The designation of the electrodes 16, 18, 20, 22 is not intended to indicate any weighting of their importance, but merely serves to distinguish them conceptually.

The sensor element 12 also has a gas entry path 24. The gas entry path 24 has a gas entry hole 26, which extends from a surface 28 of the solid electrolyte 14 into the interior of the layer structure of the sensor element 12. An electrode cavity 30 is provided in the solid electrolyte 14 and surrounds the gas entry hole 26, for example in an annular or rectangular shape. The electrode cavity 30 is part of the gas entry path 24 and is connected to the measurement gas chamber via the gas entry hole 26. For example, the gas entry hole 26 extends as a cylindrical blind hole perpendicularly to the surface 28 of the solid electrolyte 14 into the interior of the layer structure of the sensor element 12. In particular, the electrode cavity 30 is substantially annular or rectangular and is delimited by the solid electrolyte 14 from three sides when viewed in a cross-sectional view. A channel 32, which is also part of the gas entry path 24, is arranged between the gas entry hole 26 and the electrode cavity 30. In this channel 32, a diffusion barrier 34 is arranged, which reduces or even prevents the flow of gas from the measurement gas chamber into the electrode cavity 30 and only allows diffusion.

The first electrode 16 is arranged on the surface 28 of the solid electrolyte 14. The first electrode 16 can surround the gas entry hole 26 in a ring shape and be separated from the measurement gas chamber, for example, by a gas-permeable protective layer not shown in detail. The second electrode 18 is arranged in the electrode cavity 30. The second electrode 18 can likewise be annular and arranged rotationally symmetrically around the gas entry hole 26. For example, the first electrode 16 and the second electrode 18 are arranged coaxially with the gas entry hole 26. The first electrode 16 and the second electrode 18 are connected, in particular electrically connected, to the solid electrolyte 14 and in particular to the pumping layer such that the first electrode 16, the second electrode 18, and the solid electrolyte 14 form a pump cell 36. Accordingly, the first electrode 16 can also be referred to as the outer pumping electrode, and the second electrode 18 can also be referred to as the inner pumping electrode. A limiting current of the pump cell 36 can be set via the diffusion barrier 34. The limiting current thus represents a current flow between the first electrode 16 and the second electrode 18 via the solid electrolyte 14.

The sensor element 12 also has a reference gas chamber 38. The reference gas chamber 38 can extend perpendicularly to an extension direction of the gas entry hole 26 into the interior of the solid electrolyte 14. As mentioned above, the gas entry hole 26 is cylindrical so that the extension direction of the gas entry hole 26 is parallel to a cylinder axis of the gas entry hole 26. In this case, the reference gas chamber 38 extends perpendicularly to the cylinder axis of the gas entry hole 26. It is expressly mentioned that the reference gas chamber 38 can also be arranged in an imaginary continuation of the gas entry hole 26 and thus further inside the solid electrolyte 14. The reference gas chamber 38 does not have to be designed as a macroscopic reference gas chamber. For example, the reference gas chamber 38 can be designed as a so-called pumped reference, i.e., as an artificial reference.

The third electrode 20 is likewise arranged in the electrode cavity 30. For example, the third electrode 20 is opposite the second electrode 18. The fourth electrode 22 is arranged in the reference gas chamber 38. The third electrode 20 and the fourth electrode 22 are connected to solid electrolyte 14 such that the third electrode 20, the fourth electrode 22, and the part of the solid electrolyte 14 between the third electrode 22 and the fourth electrode 22 form a Nernst cell 40. By means of the pump cell 36, for example, a pump current through the pump cell 36 can be set such that the condition λ (lambda)=1 or another known composition prevails in the electrode cavity 30. This composition is in turn detected by the Nernst cell 40 by measuring a Nernst voltage UN between the third electrode 20 and the fourth electrode 22. Since a known gas composition is present in the reference gas chamber 38 or is exposed to an excess of oxygen, the composition in the electrode cavity 30 can be deduced from the measured voltage.

In the continuation of the extension direction of the gas entry hole 26, a heating element 42 is arranged in the layer structure of the sensor element 12. The heating element 42 has a heating region 44 and electrical supply paths 46. The heating region 44 is, for example, meander-shaped. The heating element 42 is arranged in the solid electrolyte 14 between the intermediate layer and the heating layer. It is expressly mentioned that the heating element 42 is surrounded on both sides by a thin layer of an electrically insulating material, such as aluminum oxide, even if this is not shown in more detail in the figures. In other words, the thin layer of the electrically insulating material is arranged between the intermediate layer and the heating element 42 and between the heating element 42 and the heating layer. Since such a layer is described, for example, in the above-mentioned related art, it is not described in more detail. For further details relating to the layer of the electrically insulating material, reference is therefore made to the above-mentioned related art, the content of which relating to the layer of the electrical material is incorporated herein by reference.

As shown in FIG. 1, the sensor 10 is connected to an electronic control unit 48. The electronic control unit 48 has a controller 50 for controlling a Nernst voltage UN of the Nernst cell 40. The sensor 10 and the control unit 48 are part of a sensor arrangement or a system 100 that comprises the sensor 10 and the control unit 48. The pump voltage Up applied to the pump cell 36 represents the manipulated variable of the electronic control unit 48 for controlling the Nernst voltage UN. The Nernst voltage UN is at the same time the controlled variable. In this way, the pump current Ip, which is dependent on the oxygen concentration and flows into or out of the pump cell 36 and which indicates the oxygen content, can also be determined.

The heating performance diagnosis for the sensor 10 is also based on a temperature derived from the resistance of the Nernst cell 40. It is therefore not possible to clearly distinguish whether the resistance of the probe ceramic is still outside the measurable range due to the temperature being too low, i.e., a possible fault in the heating element 42, or whether there is an open signal line (OL fault) at the Nernst cell 40. When a vehicle is homologated, it must be demonstrated to the authorities that a heater that is marginally within the specification (WPA, or worst performance acceptable, heater) can be robustly distinguished, using the heating performance diagnosis, from a heater that is too weak (BPU, or best performance unacceptable, heater). It is critical here that, when the diagnosis of signal line interruptions is enabled, an OL fault is not incorrectly indicated due to a probe that is too cold but is still very dynamic in the heating-up process. Hardware variations between vehicles (wiring harness, probes, etc.) can mean that no specific additional resistance can be specified for the heater circuit in order to reliably demonstrate the heating performance fault (BPU heater). The reason is that only a very narrow corridor of approximately 50 mohms remains for reliable heating performance fault detection, which is very easily exceeded by hardware variations. This can result in additional measurement effort of approximately 3 days per demonstration vehicle in order to redetermine a vehicle-specific BPU heater additional resistance.

In order to clearly detect in a simple manner whether the sensor 10 is heating up, the following method is proposed.

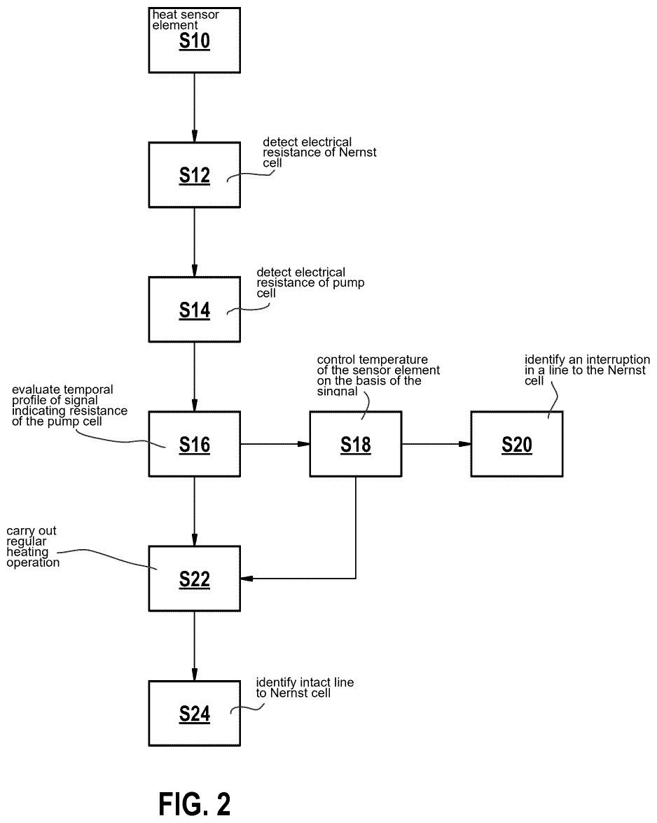

FIG. 2 shows a flowchart of a method according to the present invention for operating the sensor 10. As explained in more detail below, the method utilizes the knowledge that the pump cell resistance can be used to detect much earlier than before whether the sensor 10 is heating up. At the same time, overheating of the sensor 10 can be excluded if the heating-up phase is extended. As a result, the enabling of the diagnosis of line interruptions no longer has to be designed to ensure overheating protection in the event of an OL fault, but can be carried out with a time delay of a few seconds after the predetermined heating period has elapsed, in order to represent an additional improvement of the fault pinpointing between an open signal line and a heating performance fault.

The method begins with step S10, in which the sensor element 12 and thus the sensor 10 is heated by means of the heating element 42 for a predetermined heating period. The predetermined heating period is the maximum allowed heating-up period without temperature information via the sensor element 12 before the sensor 10 must be transferred to safe heating element operation in order to avoid overheating. In step S12, which can be carried out in parallel or simultaneously with step S10, an electrical resistance of the Nernst cell 40 is detected during the predetermined heating period, and a signal indicating the resistance of the Nernst cell 40 is generated. In step S14, which can be carried out in parallel or simultaneously with step S10, an electrical resistance of the pump cell 36 is detected during the predetermined heating period, and a signal indicating the resistance of the pump cell 36 is generated. In step S16, a temporal profile of the signal indicating the resistance of the pump cell 36 is evaluated. At the same time, a temporal profile of the signal indicating the resistance of the Nernst cell 40 is evaluated. As part of the evaluation, it is checked whether the signal indicating the resistance of the pump cell 36 and/or Nernst cell 40 falls below a resistance threshold value within the predetermined heating period. The resistance threshold value defines a resistance value below which valid temperature information for pump cell 36 and/or Nernst cell 40 can be assumed. The resistance threshold value is 4000 ohms to 8000 ohms and preferably 7000 ohms to 8000 ohms. For an enlarged resistance measuring range, significantly higher values of 50 kohms to 150 kohms are preferably used for the resistance threshold value.

If the evaluation in step S16 reveals that the signal indicating the resistance of the Nernst cell 40 does not fall below the resistance threshold value within the predetermined heating period, but the signal indicating the resistance of the pump cell 36 has already fallen below the resistance threshold value, the method proceeds to step S18. In this step, a temperature of the sensor element 12 is controlled on the basis of the signal indicating the resistance of the pump cell 36. Possible overheating of the sensor element 12 in the event of an OL fault is thereby excluded, while at the same time the heating-up process for sensors with reduced heating performance (e. g., due to additional resistances in the heater circuit) and intact lines is facilitated.

If the signal indicating the resistance of the Nernst cell 40 still does not fall below the resistance threshold value before the diagnosis of line interruptions is enabled, i.e., a few seconds after the predetermined heating period has elapsed, the method proceeds to step S20 and can identify an interruption in a line to the Nernst cell 40 and can end.

If the signal indicating the resistance of the Nernst cell 40 still falls below the resistance threshold value before the diagnosis of line interruptions is enabled, i.e., a few seconds after the predetermined heating period has elapsed, the method switches to step S22, and regular heating operation is carried out; see below.

If the evaluation in step S16 reveals that the signals indicating the resistance of the pump cell 36 and Nernst cell 40 both fall below the resistance threshold value within the predetermined heating period, the method proceeds to step S22, and regular heating operation is carried out. After the diagnosis of line interruptions is enabled, i.e., a few seconds after the predetermined heating period has elapsed, the method can proceed to step S24, identify an intact line to the Nernst cell 40 and/or pump cell 36, and end.

The method can further comprise arranging additional resistances of different magnitudes in a circuit of the heating element 42, wherein steps S10 to S24 are each carried out with the additional resistances of different magnitudes. The arrangement of such an additional resistance in the circuit of the heating element 42 can selectively be carried out either in the positive line of the heating element 42, the negative line of the heating element 42, or in both of the said lines simultaneously. Thus, it was not possible to detect any difference in the heating-up behavior of the sensor 10 due to different positioning of the additional resistances.

For example, when a vehicle is homologated, a WPA heater must be distinguished from a BPU heater on the basis of different additional resistances in the heater circuit. Since the pump cell of a two-cell probe typically has a lower internal resistance than the Nernst cell at the same temperature, the heating-up of the sensor element can be detected early on the basis of its signal profile. This can be used to extend the heating-up phase, since an OL-IPE fault and thus overheating of the sensor can be ruled out early in this case. As a result, the enabling of the diagnosis of line interruptions no longer has to be designed to ensure overheating protection in the event of an OL fault, but can be carried out with a time delay of a few seconds after the predetermined heating period has elapsed, in order to represent an additional improvement of the fault pinpointing between an open signal line and a heating performance fault. As a result, a higher additional resistance can be selected for the BPU heater in order to increase the robustness of correct fault detection during the official demonstration and to minimize additional measurement effort.

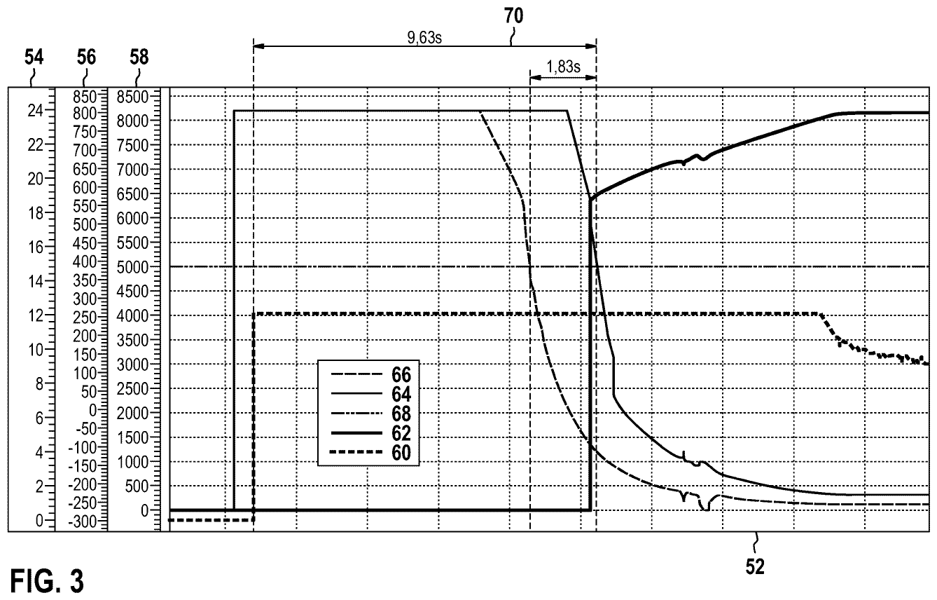

FIG. 3 shows exemplary signal profiles of the sensor 10 during operation of the heating element 42. The signal profiles shown illustrate why heating control based on use of the pump cell resistance or the temperature derived therefrom is suitable for improving the fault pinpointing between an open signal line and a heating performance fault (cold probe or probe heating up too slowly). In FIG. 3, the time in seconds is plotted on the x-axis 52. The electrical heating voltage (effective value) applied to the heating element is plotted in V on the y-axis 54 shown on the far left. The temperature of the sensor element 12 is plotted in ° C. on the second y-axis 56 from the left. The resistance of the Nernst cell 40 and the resistance of the pump cell 36 are plotted in ohms on the third y-axis 58 from the left. The curve 60 represents the temporal profile of the electrical heating voltage applied to the heating element. The curve 62 represents the temporal profile of the measured temperature over the Nernst cell resistance of the sensor element 12. The curve 64 represents the temporal profile of the resistance of the Nernst cell 40. The curve 66 represents the temporal profile of the resistance of the pump cell 36. In this example, the maximum evaluable value for the two curves 64 and 66 is approximately 8200 ohms. The curve 68 represents the resistance threshold value for the electrical resistance of the pump cell 36 or Nernst cell 40, below which valid temperature information for the pump cell 36 and/or Nernst cell 40 can be assumed. A value of 5000 ohms is selected by way of example.

The exemplary signal profiles in FIG. 3 represent the heating-up behavior of the sensor 10 with an additional resistance of 1.5 ohms in the heater circuit. The range 70 indicates the predetermined heating period or the permitted heating-up period without temperature information via the sensor 10 before the sensor 10 must be transferred to safe heater operation in order to avoid overheating. In order to rule out an OL-IPE fault and thus overheating of the sensor, the resistance of the Nernst cell 40 or pump cell 36 must fall below the resistance threshold value within this period. As shown in FIG. 3, in the example shown, the resistance of the Nernst cell 40 falls below the resistance threshold value after 9.63 s since the curve 64 falls below the resistance threshold value 68 at this time, while valid temperature information of the sensor 10 is already available 1.83 s earlier via the pump cell 36, with the same resistance threshold value, and thus overheating of the sensor can be ruled out since the curve 66 falls below the resistance threshold value 68 at the time 7.80 s. This time delay (approx. 18% of the predetermined heating-up period), as well as the decoupling of the overheating protection from the enabling of the diagnosis of line interruptions, allows the targeted selection of a (higher) additional resistance in order to be able to distinguish a WPA heater from a BPU heater robustly, taking into account all possible operating and vehicle variations.

The method according to the present invention can be used in all heated exhaust gas probes that have at least two measuring cells, such as two-cell lambda probes or NOX sensors. The method according to the present invention can be demonstrated by comparing measurements of the profile of the effective heater voltage, pump cell resistance, and Nernst cell resistance during the heating-up phase with different additional resistances in the heater circuit. The method according to the present invention can also be demonstrated by comparing measurements of the profile of the effective heater voltage, pump cell resistance, and Nernst cell resistance with an open line in one signal line each.

1-11. (canceled)

12. A method for operating a sensor for detecting at least one property of a measurement gas in a measurement gas chamber, wherein the sensor has a sensor element for detecting the property of the measurement gas, wherein the sensor element has at least one Nernst cell, at least one pump cell, and at least one heating element, wherein the method comprises the following steps:
a) heating the sensor element for a predetermined heating period using the heating element;
b) detecting an electrical resistance of the Nernst cell during the predetermined heating period and generating a signal indicating the resistance of the Nernst cell;
c) detecting an electrical resistance of the pump cell during the predetermined heating period and generating a signal indicating the resistance of the pump cell;
d) evaluating a temporal profile of the signals indicating the resistance of the pump cell and Nernst cell, wherein a check is made as to whether the signal indicating the resistance of the pump cell and/or the Nernst cell falls below a resistance threshold value within the predetermined heating period; wherein:
e) when the evaluation reveals that the signal indicating the resistance of the Nernst cell does not fall below the resistance threshold value within the predetermined heating period, but the signal indicating the resistance of the pump cell has already fallen below the resistance threshold value, a temperature of the sensor element is controlled based on the signal indicating the resistance of the pump cell, and
f) when the signal indicating the resistance of the Nernst cell still falls below the resistance threshold value before a diagnosis of line interruptions is enabled, regular heating operation is carried out using temperature control based on the resistance of the Nernst cell.

13. The method according to claim 12, wherein the sensor is for detecting a content of a gas component in the measurement gas.

14. The method according to claim 12, wherein the resistance threshold value defines a resistance value below which valid temperature information for the pump cell and/or the Nernst cell can be assumed.

15. The method according to claim 12, further comprising arranging additional resistances of different magnitudes in a circuit of the heating element, wherein the steps a) to f) each being carried out with the additional resistances of different magnitudes.

16. The method according to claim 12, wherein the resistance threshold value is 4000 ohms to 150 kohms.

17. The method according to claim 12, further comprising identifying an interruption in a line to the Nernst cell and/or the pump cell after the diagnosis of line interruptions has been enabled, and ensuring overheating protection of the sensor element when the signal indicating the resistance of the Nernst cell and/or the pump cell does not fall below the resistance threshold value within the predetermined heating period.

18. The method according to claim 12, wherein, when an interruption in the line to the Nernst cell is identified, a temperature of the sensor element is controlled based on the signal indicating the resistance of the pump cell.

19. The method according to claim 12, further comprising identifying an intact line to the Nernst cell and/or the pump cell after the diagnosis of line interruptions has been enabled, when the signal indicating the resistance of the Nernst cell and/or the pump cell falls below the resistance threshold value within the predetermined heating period.

20. A system, comprising:
at least one sensor configured to detect at least one property of a measurement gas in a measurement gas chamber, wherein the sensor has a sensor element for detecting the property of the measurement gas, wherein the sensor element has at least one Nernst cell, at least one pump cell, and at least one heating element; and
at least one controller including at least one processor, wherein the controller is configured to;
a) heat the sensor element for a predetermined heating period using the heating element,
b) detect an electrical resistance of the Nernst cell during the predetermined heating period and generating a signal indicating the resistance of the Nernst cell,
c) detect an electrical resistance of the pump cell during the predetermined heating period and generating a signal indicating the resistance of the pump cell,
d) evaluate a temporal profile of the signals indicating the resistance of the pump cell and the Nernst cell, wherein a check is made as to whether the signal indicating the resistance of the pump cell and/or the Nernst cell falls below a resistance threshold value within the predetermined heating period, wherein:
e) when the evaluation reveals that the signal indicating the resistance of the Nernst cell does not fall below the resistance threshold value within the predetermined heating period, but the signal indicating the resistance of the pump cell has already fallen below the resistance threshold value, a temperature of the sensor element is controlled based on the signal indicating the resistance of the pump cell, and
f) when the signal indicating the resistance of the Nernst cell still falls below the resistance threshold value before a diagnosis of line interruptions is enabled, regular heating operation is carried out using temperature control based on the resistance of the Nernst cell.

21. A non-transitory data carrier on which a data structure is stored which is configured to carry out a method after being loaded into a working and/or main memory of a computer or computer network, the method being for operating a sensor for detecting at least one property of a measurement gas in a measurement gas chamber, wherein the sensor has a sensor element for detecting the property of the measurement gas, wherein the sensor element has at least one Nernst cell, at least one pump cell, and at least one heating element, and the method comprising the following steps:
a) heating the sensor element for a predetermined heating period using the heating element;
b) detecting an electrical resistance of the Nernst cell during the predetermined heating period and generating a signal indicating the resistance of the Nernst cell;
c) detecting an electrical resistance of the pump cell during the predetermined heating period and generating a signal indicating the resistance of the pump cell;
d) evaluating a temporal profile of the signals indicating the resistance of the pump cell and Nernst cell, wherein a check is made as to whether the signal indicating the resistance of the pump cell and/or the Nernst cell falls below a resistance threshold value within the predetermined heating period; wherein:
e) when the evaluation reveals that the signal indicating the resistance of the Nernst cell does not fall below the resistance threshold value within the predetermined heating period, but the signal indicating the resistance of the pump cell has already fallen below the resistance threshold value, a temperature of the sensor element is controlled based on the signal indicating the resistance of the pump cell, and
f) when the signal indicating the resistance of the Nernst cell still falls below the resistance threshold value before a diagnosis of line interruptions is enabled, regular heating operation is carried out using temperature control based on the resistance of the Nernst cell.

22. An electronic control unit, comprising:
a non-transitory data carrier on which a data structure is stored which is configured to carry out a method after being loaded into a working and/or main memory of a computer or computer network, the method being for operating a sensor for detecting at least one property of a measurement gas in a measurement gas chamber, wherein the sensor has a sensor element for detecting the property of the measurement gas, wherein the sensor element has at least one Nernst cell, at least one pump cell, and at least one heating element, and the method including the following steps:
a) heating the sensor element for a predetermined heating period using the heating element;
